(19) United States
(12) Patent Application Publication
(10) Pub. No.: US 2003/0163994 A1
(43) Pub. Date: Sep. 4, 2003

(54) Generator set for vegetable oil and method of operating the same

(75) Inventors: Masamichi Kuramoto, Tokyo (JP); Yoshihiko Asano, Tokyo (JP); Yuuji Ogawa, Saitama (JP); Toshiharu Satou, Saitama (JP); Yasuyuki Mizobuchi, Tokyo (JP)

Correspondence Address: FOLEY AND LARDNER, SUITE 500, 3000 K STREET NW, WASHINGTON, DC, 20007, US

(73) Assignee: KABUSHIKI KAISHA MEIDENSHA

(21) Appl. No.: 10/322,791

(22) Filed: Dec. 19, 2002

(30) Foreign Application Priority Data
Dec. 21, 2001 (JP) 2001-388796
Jun. 12, 2002 (JP) 2002-170793

(51) Int. Cl. F02C 7/22

(52) U.S. Cl. 60/776; 60/39.463

(57) ABSTRACT

A generator set employs a gas turbine which selectively uses reformed vegetable oil and fluid fuel. The generator set operates so as to supply the reformed vegetable oil to the gas turbine when a temperature of the reformed vegetable oil is higher than a predetermined temperature and when a load is applied to the gas turbine, and to supply the fluid fuel to the gas turbine when the temperature of the reformed vegetable oil is lower than the predetermined temperature or when no load is applied to the gas turbines

### BACKGROUND OF THE INVENTION

The present invention relates to a gas-turbine generator set which employs used or outdated vegetable oil as fuel, and a method of operating the generator set.

A gas turbine has come in wide use as a generator set by reason of clean exhaust emission particularly in nitrogen oxide NOx. Specifically, a micro gas turbine has received widespread attention. Such a micro gas turbine employs LNG and LPG of gaseous form and light oil and kerosene of liquid form.

### SUMMARY OF THE INVENTION

Several groups have researched to use waste vegetable oil as fuel for diesel engines by reforming the vegetable oil into methylester. Since such reformed oil has a high flash point, it is difficult to use the reformed vegetable oil as fuel of diesel engines.

Inventors of the present invention have researched an application of such reformed vegetable oil to a generator set employing a gas turbine. As a result of this research, the inventers reached the prevent invention.

It is therefore an object of the present invention to provide a generator set which employs a gas turbine operated by using reformed vegetable oil as fuel, and to provide a method of operating such a generator set.

An aspect of the present invention resides in a generator set for reformed vegetable oil. The generator set comprises a fluid fuel tank which stores fluid fuel, a vegetable oil tank which stores reformed vegetable oil, a gas turbine which generates electric power by consuming the fluid fuel and the reformed vegetable oil as fuel, a fuel supply control section, and first and second valves The fuel supply control section is fluidly connected to the fluid fuel tank, the vegetable oil tank and the gas turbine. The fuel supply control section controls pressure of the fluid fuel supplied from the fluid tank and the reformed vegetable oil supplied from the vegetable oil tank. The fuel supply control section supplies the pressure controlled fluid fuel and the pressure controlled reformed vegetable oil to the gas turbine. The first and second valves selectively supply the fluid fuel in the fluid fuel tank and the reformed vegetable oil in the vegetable oil tank to the fuel supply control section.

Another aspect of the present invention resides in a generator set for reformed vegetable oil, which generator set comprises a gaseous fuel supply section which supplies gaseous fuel, a vegetable oil tank which stores reformed vegetable oil, a gas turbine which generates electric power by using the gaseous fuel and the reformed vegetable oil as fuel, a fuel supply control section, a booster which is connected to the gaseous fuel supply section, a first valve which is disposed in a passage connecting the booster and the gas turbine and a second valve which is disposed in a passage connecting the vegetable oil tank and the fuel supply control section. The fuel supply control section is fluidly connected to the reformed vegetable oil tank and the gas turbine. The fuel supply control section controls pressure of the reformed vegetable oil supplied from the vegetable oil tank. The fuel supply control section supplying the pressure controlled reformed vegetable oil to the gas turbine. The booster pressurizes the gaseous fuel at a predetermined pressure value. The first valve is selectively opened and closed to selectively supply and stop the gaseous fluid to the gas turbine. The second valve is selectively closed and opened to selectively stop and supply the reformed vegetable oil to the gas turbine.

A further another aspect of the present invention resides in a generator set for reformed vegetable oil which comprises a fluid fuel tank storing fluid fuel, a vegetable oil tank storing reformed vegetable oil, a gas turbine generating electric power by using one of the fluid fuel and the reformed vegetable oil as fuel, a fuel supply control section, first and second valves, and a controller. The fuel supply control section is fluidly connected to the fluid fuel tank, the vegetable oil tank and the gas turbine. The fuel supply control section controls pressure of the fluid fuel supplied from the fluid tank and the reformed vegetable oil supplied from the vegetable oil tank. The fuel supply control section supplies the pressure controlled fluid fuel and the pressure controlled reformed vegetable oil to the gas turbine. The first and second valves selectively supply the fluid fuel in the fluid fuel tank and the reformed vegetable oil in the reformed vegetable oil tank to the fuel supply control section. The controller is coupled to the gas turbine, the fuel supply control section and the first and second valves. The controller is configured to receive a gas-turbine operation signal indicative that the gas turbine is in an operable state and a load signal indicative that a load is applied to the gas turbine, from the gas turbine, to receive a fuel supply condition signal indicative of a condition of the reformed vegetable oil from the fuel supply control section, to command the fuel supply control section and the first and second valves to supply the reformed vegetable oil when the controller determines from the fuel supply condition signal that a temperature is of the reformed vegetable oil is higher than a predetermined value and when the controller receives the load signal, and to command the fuel supply control section, the first valve and the second valve to supply the fluid fuel when the controller does not receive the load signal.

A further another aspect of the present invention resides in a method of operating a generator set. The generator set comprises a gas turbine which selectively uses reformed vegetable oil and-fluid fuel. The method comprises a step of supplying the reformed vegetable oil to the gas turbine when a temperature of the reformed vegetable oil is higher than a predetermined temperature and when a load is applied to the gas turbine and a step of supplying the fluid fuel to the gas turbine when the temperature of the reformed vegetable oil is lower than the predetermined temperature or when no load is applied to the gas turbine.

The other objects and features of this invention will become understood from-the following description with reference to the accompanying drawings.

### BRIEF DESCRIPTION OF THE DRAWINGS

FIG. 1 is a schematic diagram showing a first embodiment of a generator set of according to the present invention.

FIG. 2 is a graph showing an experimental result as to an output characteristic of a gas turbine in the generator set of FIG. 1.

FIG. 3 is a flowchart showing an operation of the generator set of FIG. 1.

FIG. 4 is a schematic diagram showing a second embodiment of the generator set according to the present invention.

FIG. 5 is a schematic diagram showing a third embodiment of the generator set according to the present invention.

FIG. 6 is a schematic diagram showing a fourth embodiment of the generator set according to the present invention.

FIG. 7 is a graph showing an experimental result as to an output characteristic of the gas turbine in the generator set of FIG. 6.

### DETAILED DESCRIPTION OF THE INVENTION

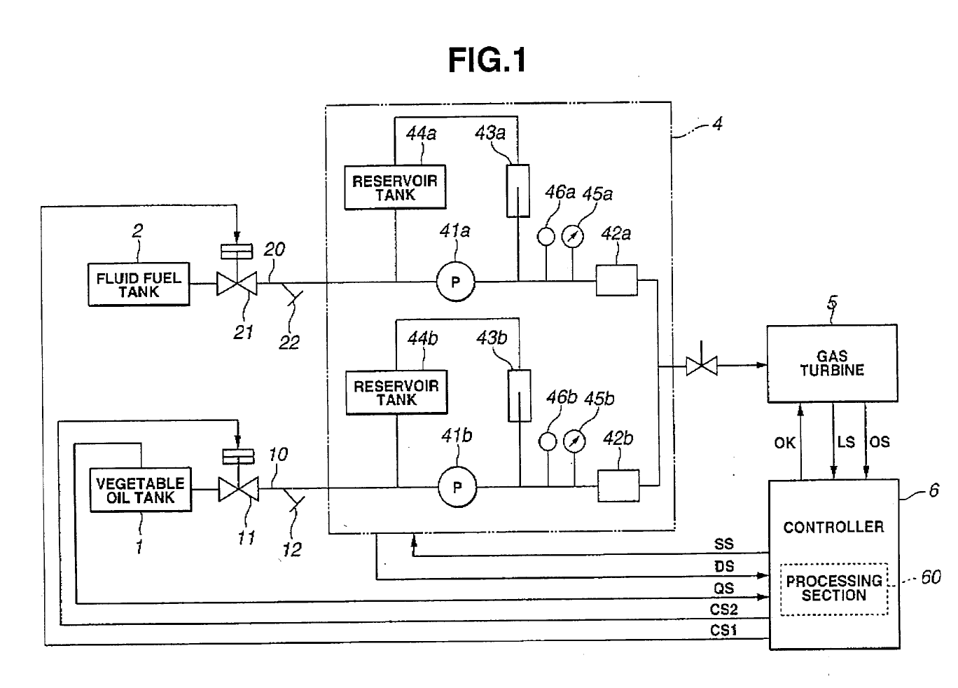

Referring to FIGS. 1 through 3, there is shown a first embodiment of a generator set according to the present invention.

As shown in FIG. 1, the generator set of the first embodiment employs a gas turbine 5 as a generator. The generator set comprises a vegetable oil tank 1, a fluid fuel tank 2, a fuel supply control section 4, a gat turbine 5 and a controller 6.

The vegetable oil tank 1 stores reformed oil of used frying oil or outdated eatable oil (hereinafter the reformed oil is called vegetable oil), and the fluid fuel tank 2 stores kerosene or light oil (hereinafter, these oils are representatively called kerosene). A first passage 20 connects the fluid fuel tank 2 and the fuel supply control section 4, and a second passage 10 connects the vegetable oil tank 1 and a fuel supply control section 4. A first solenoid value 21 and a first strainer 22 are installed in the first passage 20, and a second solenoid valve 11 and a second strainer 12 are installed in the second passage 10.

The fuel supply control section 4 has a function of controlling a pressure of fuel to be supplied to the gas turbine 5. The fuel supply control section 4 comprises pumps 41a and 41b, flow meters 42a and 42b, relief valves 43a and 43b, reservoir tanks 44a and 44b, pressure gages 45a and 45b, and fuel temperature detectors 46a and 46b, More specifically, connected to the first passage 20 are the first pump 41a, the first flow meter 42a, the first relief valve 43a and the first reservoir tank 44a, a first pressure gage 45a and the first fuel temperature detector 46a, as is clearly shown in FIG. 1. Similarly, connected to the second passage 10 are the second pump 41b, the second flow meter 42b, the second relief valve 43b, the second reservoir tank 44b, the second pressure gage 45b and the second fuel temperature detector 46b, as is clearly shown in FIG. 1.

The gas turbine 5 employed in this generator set of the first embodiment is a micro gas turbine which comprises a combustion chamber, a compressor, a generator and the like though not shown. A cogeneration system using such a micro gas turbine is advantageous in view of fuel efficiency.

The controller 6 is coupled to the fuel supply control section 4 and the gas turbine 5 to receive various information and to output control command signals to the fuel supply control section 4, the gas turbine 5, the first solenoid value 21 and the second solenoid valve 11. More particularly, a processing section 60 of the controller 6 receives a gas-turbine operable signal OS and a load signal LS from the gas turbine 5 and outputs a start signal OK indicative of a start allowable state of a fuel supply equipment including the tanks 1 and 2, and the fuel supply control section 4. The gas-turbine operable signal OS represents that the gas turbine 5 is in an operable state, and the load signal LS represents that a load is applied to the gas turbine 6.

Further, the controller 6 receives an oil storage quantity indicative signal QS from the vegetable oil tank 1, and further receives a supply condition signal DS indicative of temperatures and flow rates of reformed vegetable oil and fluid oil from the fuel supply control section 4 which comprises or interconnected with an oil reformer (not shown). Further, the controller 6 outputs an operation start signal SS to the fuel supply control section 4. The controller 6 determines the states of the respective elements and detects an abnormality of a fuel supply condition, on the basis of the detected signals. More specifically, controller 6 checks clogging of the passages 10 and 20 and a fuel empty state. When the controller 6 detects some problems such as the clogging of passages or the fuel empty state, the controller 6 outputs an information signal to inform an abnormal state of this equipment to an operator so that the operator can smoothly execute maintenance of the generator set. Further, controller 6 outputs a first command signal CS1 to the first solenoid valve 21 to change an open state of the first solenoid valve 21, and output a second command signal CS2 to the second solenoid value 11 to change an open state of the second solenoid valve 11.

TABLE I

| | | |
|---|---|---|
| DENSITY | (g/cm²) | 0.85-0.9 |
| FLASH POINT | (° C.) | 180-190 |
| KINEMATIC VISCOSITY | (mm²/S) | 5.8˜6.2 |
| POUR POINT | (° C.) | −3˜−1 |
| CALORIFIC VALUE | (kcal/kg) | 9400˜9600 |
| SULFUR | (wt %) | Not more than 0.05 |

Table I shows general properties of reformed vegetable oil (reformed frying oil). As shown in Table I, a flash point of reformed vegetable oil ranges from 180 to 190° C., and therefore it is impossible to execute a cold start of the gas turbine 5 using reformed vegetable oil.

Accordingly, it is necessary to start the gas turbine 5 using fluid fuel such as kerosene. This kerosene used starting is executed by putting the second solenoid valve 21 in an open state to be able to supply kerosene through the first passage 20, the first pump 41a and the first flow meter 42a to the gas turbine 5. During this period, the first relief valve 43a controls a flow rate of kerosene so as to supply a predetermined flow rate of kerosene to the gas turbine 5 and to return an excessive quantity of kerosene through the first reservoir tank 44a to an inlet side of the first pump 41a.

When the temperature in a combustion chamber of the gas turbine 5 is raised and reaches the flash point of the reformed vegetable oil after a predetermined time period elapsed, the first solenoid valve 21 is put in the closed state to stop supplying kerosene to the gas turbine 5 and the second solenoid value 11 is opened to start supplying vegetable oil to the gas turbine 5. Main foreign materials in vegetable oil are filtered by the second strainer 12, and the filter vegetable oil is supplied through the second pump 41b and the second flow meter 42b to the gas turbine 5.

Vegetable oil used as fuel is restricted in quantity since the oil is waste oil. Accordingly, when reformed vegetable oil in the vegetable oil tank 1 becomes empty, the states of the first and second solenoids 21 and 12 are changed so that kerosene is supplied to the gas turbine 5.

The switching from reformed vegetable oil to kerosene causes the following problems.

Oils and fats of vegetable oil are mainly a mixture constructed by gathering a large quantity of triacylglycerol formed by bonding three fatty acid with glycerol. Due to containing glycerol, such oils and fats performs high viscosity. Therefore, it is necessary to separate triacylglycerol into glycerol and fatty ester by means of the ester interchange reaction by which triacylglycerol reacts with methanol through alkaline catalyst to form glycerol and fatty ester. In order to remove glycerol from the produced mixture, it is necessary to rinse the produced mixture of glycerol and fatty ester with water. However, if water is remained with the remains of the mixture, there is a possibility that emulsification is made by stirring the remained water and the kerosene with a low polarity. Such emulsification causes the fluctuation of the temperature and the output of the gas turbine when the switch between the fluid fuel and reformed vegetable oil is executed. Therefore, in this embodiment, the reformed vegetable oil is treated so as not to remain water therewith.

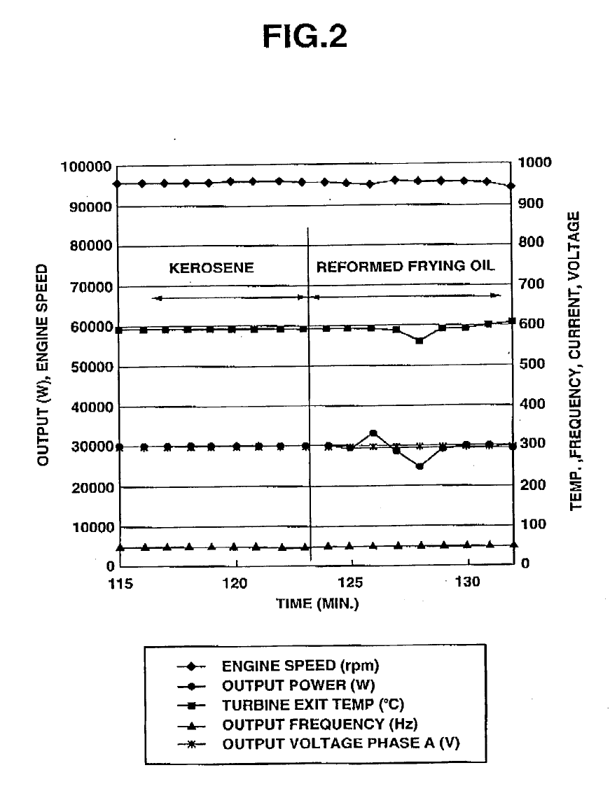

FIG. 2 shows experimental data during a switching from kerosene to reformed frying oil. In this experiment, the gas turbine 5 employed kerosene as fuel until 123 minutes elapsed. Thereafter, kerosene was switched to reformed frying oil. When 2 minutes elapsed from the switching from kerosene to reformed frying oil, that is, when 125 minutes elapsed from a start of the gas turbine 5, the gas turbine 5 started the fluctuation in temperature and output. Although this fluctuation does not affect a practical operation of the gas turbine 5, the supply line of kerosene and a supply line of reformed vegetable oil are independently formed in the fuel supply control section 4 to certainly prevent such a fluctuation.

However, if reformed vegetable oil remains in the fuel supply pipe between the fuel supply control section 4 and the gas turbine 5 or in the combustion chamber of the gas turbine 5 at a moment that the gas turbine 5 is stopped, the next starting of the gas turbine 5 is disabled. Therefore, when the gas turbine 5 is stopped, it is necessary that an operation using kerosene is executed for a predetermined time so that no reformed vegetable oil remains in the fuel supply pipe and the combustion chamber. Further, since waste vegetable oil performs high viscosity, it is necessary to warm waste vegetable oil until the temperature of waste vegetable oil becomes higher than a predetermined temperature, in order to effectively use it as fuel.

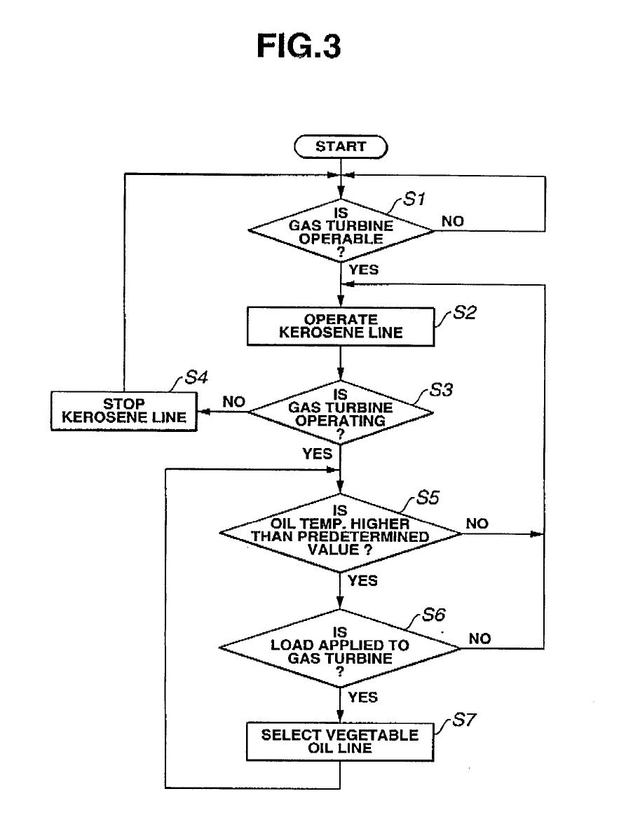

A processing section 60 of the controller 6 practically executes the processing shown by a flowchart of FIG. 3, in order to certainly exchange the fuel in the fuel supply pipe and the combustion chamber with kerosene. By executing a flowchart of FIG. 3, the elements in the fuel supply control section 4 execute operations for enabling the gas turbine 5 to smoothly restart.

At step S1 in FIG. 3 the processing section 60 of the controller 6 determines whether or not the gas turbine 5 outputs the gas-turbine operable signal OS. When the negative determination is made at step S1, that is, when the gas turbine 5 is not turned on, the routine repeats step S1 until the affirmative determination is made. When the affirmative determination made at step S1, that is, when the gas turbine 5 is turned on, the routine proceeds to step S2.

At step S2 the processing section 60 outputs the first command signal CS1 to the first solenoid valve 21 and the start command signal DS to the first pump 41a to start supplying kerosene to the fuel supply control section 4. Further, the processing section 60 outputs the start signal OK upon receiving the supply condition signal DS indicative that the fuel supply control section is put in a kerosene supply state. The gas turbine 5 is turned on to start operation in reply to the start signal OK outputted from the controller 60.

At step S3 the processing section 60 determines whether or not whether the gas turbine 5 is in an operating state. When the determination at step S3 affirmative, the routine proceeds to step S5 wherein the processing section 60 determines whether or not the flowability of vegetable oil is greater than a predetermined value. When the determination at step S5 is affirmative, that is, when vegetable oil performs the flowability sufficient as fuel, the routine proceeds to step S6. When the determination at step S5 is negative, the routine returns to step S2.

At step S6 the processing section 60 determines whether or not the gas turbine 5 outputs the load signal LS indicative that some load is applied to the gas turbine 5. When the determination at step S6 is affirmative, the processing section 60 outputs a switching command signal to the fuel supply control section 4 to switch the operable line from the kerosene line to the vegetable oil line. More specifically, the processing section 60 commands the fuel supply control section 4 to turn off the first solenoid valve 21 and the first pump 41a and to turn on the second solenoid valve 11 and the second pump 41b. By this operation of the fuel supply control section 4 according to the switching command signal, reformed vegetable oil is supplied to the combustion chamber of the gas turbine 5, and the operation of the gas turbine 5 is continued.

Subsequently, there will be discussed the operation for stopping the gas turbine 5.

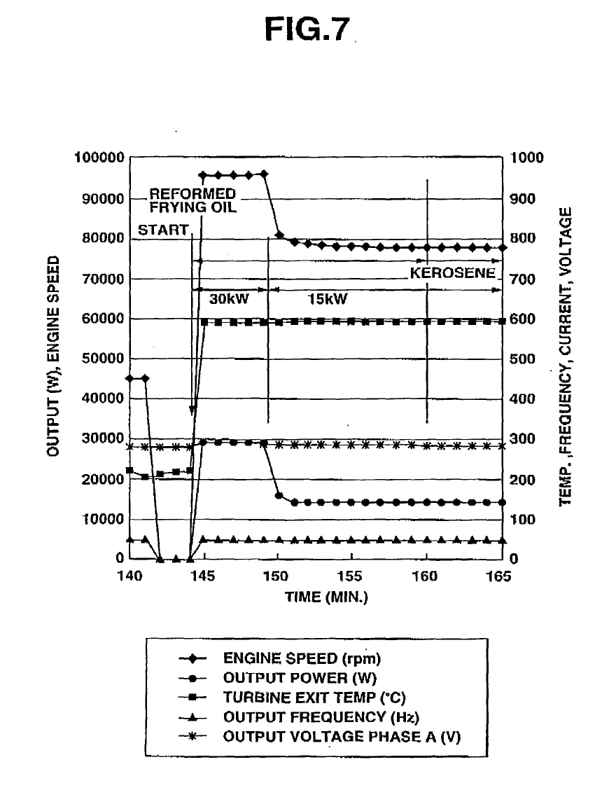

When the gas turbine 5 is stopped, the gas turbine 5 is separated from the load and executes a cleaning operation under a no-load condition. That is, at step S6 in FIG. 7 the processing section 60 determines whether or not the gas turbine 5 outputs the load signal LS. When the determination at step S6 is negative, that is, when the gas turbine 5 does not outputs the load signal LS, the routine returns to step S2 so that the gas turbine 5 executes the cleaning operation using kerosene. Accordingly, the fuel in the combustion chamber is changed into kerosene. Then, when the negative determination is made at step S3, that is, when the gas turbine 5 stops outputting the operation signal OS, the routine proceeds to step S4 wherein the supply of kerosene is stopped for the next start of the gas turbine.

Further, when the processing section 60 determines that the remaining quantity of the vegetable oil in the vegetable oil tank 1 becomes smaller than a predetermined quantity, the processing section 60 executes the switching operation from vegetable oil to fluid fuel. That is, a detector for detecting the remained quantity of vegetable oil is attached to the vegetable oil tank 1 so as to detect an upper limit and a lower limit of the quantity of vegetable oil in the tank 1. The remained quantity detector may be a limit switch, and outputs the quantity signal QS indicative of the remained quantity of vegetable oil in the tank 1 to the processing section 60. When the processing section 60 determines from the quantity signal OS that the remained quantity of vegetable oil in the tank 1 is decreased to the lower limit or when the processing section 60 determines from the detecting value of the second pressure gage 45b that the pressure in the vegetable oil line is high and in the abnormal state, the processing section 60 commands the fuel supply control section 4 to switch the fuel supply line from the vegetable oil line to the kerosene line.

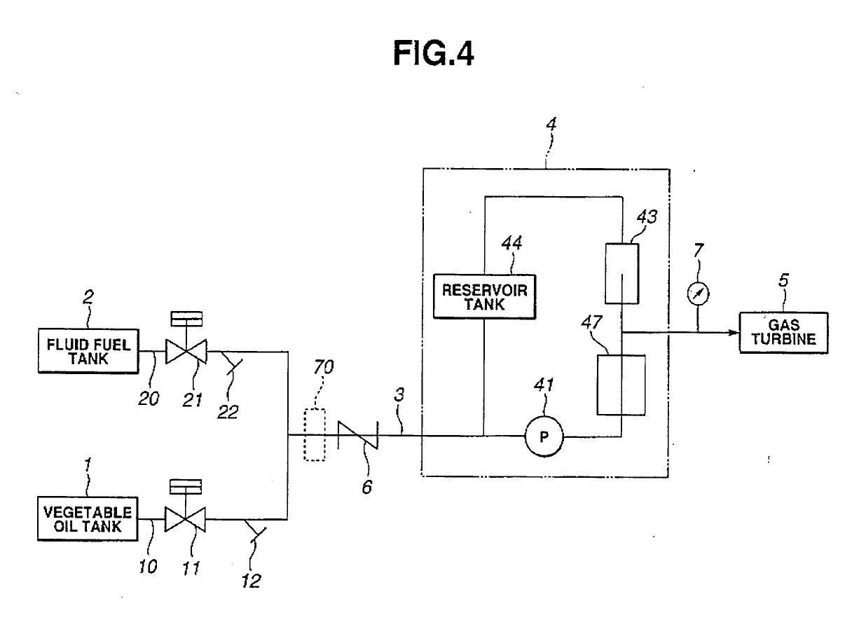

Referring to FIG. 4, there is shown a second embodiment of the generator set according to the present invention.

In this second embodiment, elements and components as same as those of the first embodiment are denoted by the same reference numerals employed in the first embodiment, and the explanation thereof is basically omitted herein.

The construction of the generator set of the second embodiment is simplified as compared with the first embodiment. The controller 6 for controlling the fuel supply control section and the gas turbine 5 is omitted in this second embodiment.

Herein only a variation of a connection structure between the tanks 1 and 2 and the fuel supply control section will be discussed. Since the operation of this generator set of the second embodiment is basically the same as that of the first embodiment, the explanation therefore is omitted herein.

As shown in FIG. 4, the vegetable oil tank 1 is connected to the fuel supply control section 4 through the second passage 10 and a common passage 3, and the fluid fuel tank 1 is connected to the fuel supply control section 4 through the first passage 20 and the common passage 3. Both output ends of the first and second passages 20 and 10 are combined and are connected to the common passage 3. The first solenoid valve 21 and the first strainer 22 are installed in the first passage 20, and the second solenoid valve 11 and the second strainer 12 are installed in the second passage 10. Installed in the common passage 3 in a valve 6 for controlling a flow rate of fuel and for preventing the fuel from the fuel supply control section 4 to the tanks 1 and 2.

The fuel supply control section 4 of the second embodiment is basically constructed by a pump 41, a filter 47, a relief valve 43 and a reservoir tank 44. The relief value 43 maintains the pressure of the fuel to be supplied to the gas turbine 5 at a preset value and returns the excessive fuel to the pump 41 through the reservoir tank 44. A pressure gage 7 is installed in a passage connecting the fuel supply control section 4 and the gas turbine 5. In order to further certainly prevent the pump 41 from being put in an inoperative state due to an emulsification clogging to the filter 47, the filter 47 is disposed at an output side of the pump 41 without being disposed at an inlet side portion 70 shown by a dotted line in FIG. 4.

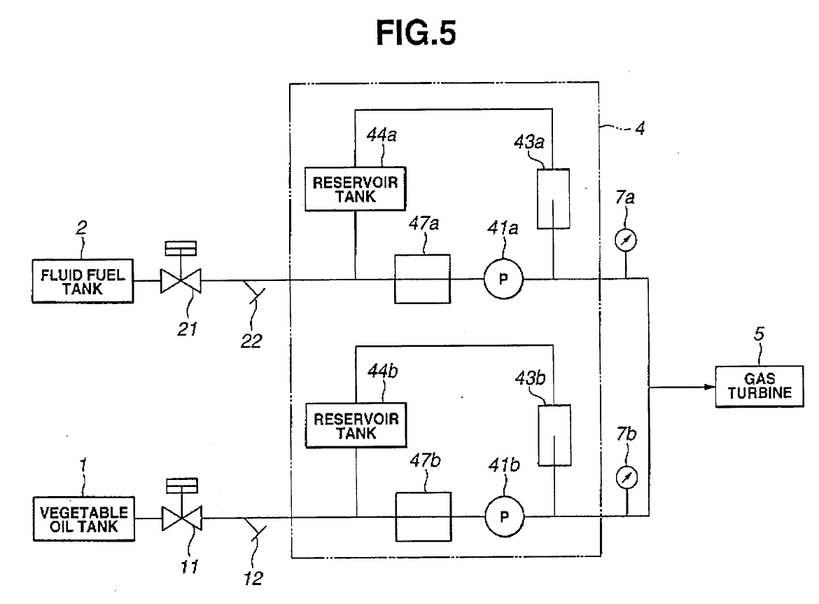

Referring to FIG. 5, there is shown a third embodiment of the generator set according to the present invention.

In this third embodiment, elements and components as same as those of the first embodiment are denoted by the same reference numerals employed in the first embodiment, and the explanation thereof is basically omitted herein. The construction of the generator set of the third embodiment is relatively simple as compared with the first embodiment. The controller 6 for controlling the fuel supply control section and the gas turbine 5 is omitted in this third embodiment. Herein only a variation of a connection structure between the tanks 1 and 2 and the fuel supply control section will be discussed. Since the operation of this generator set of the third embodiment is basically the same as that of the first embodiment, the explanation therefore is omitted herein.

In this third embodiment, a supply line of the vegetable oil and a supply line of fluid fuel are independently formed from the respective tanks 1 and 2 to the output end of the fuel supply control section 4, as are similar to those of the first embodiment.

More specifically, installed in the passage connecting the fluid fuel tank 2 to the gas turbine 5 through the fuel supply control section 4 are the first solenoid valve 21, the first strainer 22, the first filter 47a, the first pump 41a, the first relief valve 43a, the first reservoir tank 44a and a first pressure gage 7a. Similarly, installed in the passage connecting the vegetable oil tank 1 to the gas turbine 5 through the fuel supply control section 4 are the second solenoid valve 11, the second strainer 12, the second filter 47b, the second pump 41b, the second relief valve 43b, the second reservoir tank 44b and the second pressure gage 7b. In each of the vegetable oil line and the fluid fuel line, the alignment of the respective elements are basically same as that of the second embodiment except that each filter 47a, 47b is disposed at an inlet side of each pump 41a, 41b.

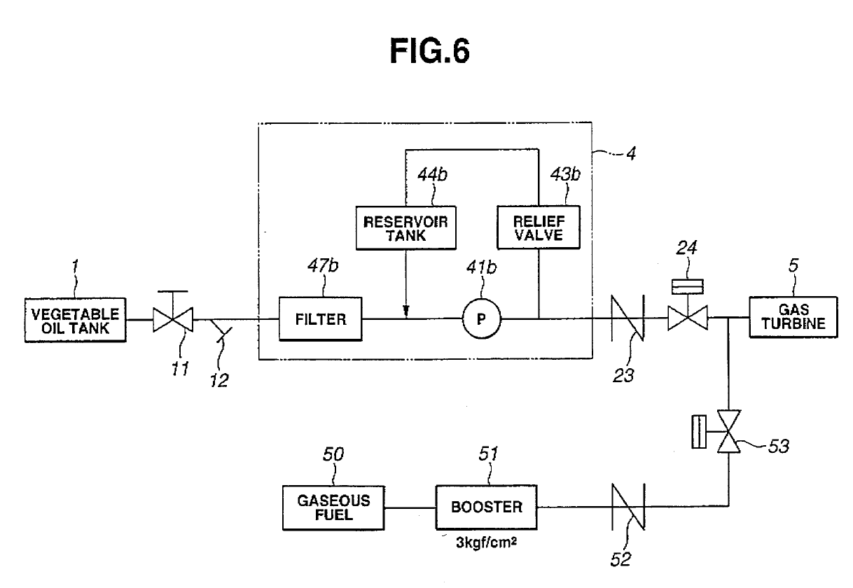

Referring to FIGS. 6 and 7, there is shown a fourth embodiment of the generator set according to the present invention.

In this fourth embodiment, elements and components as same as those of the first embodiment are denoted by the same reference numerals employed in the first embodiment, and the explanation thereof is basically omitted herein.

The fourth embodiment is arranged to use gaseous fuel such as LNG (liquefied natural gas) and LPG (liquefied petroleum gas), instead of fluid fuel. A booster 51 is connected to a gaseous fuel supply section 50 and pressurizes gaseous fuel to a pressure of about 3 kgf/cm2. The booster 51 is connected to the gas turbine 5 through a pipe wherein a check valve 53 and a solenoid valve 53 without passing through the fuel supply control section 4.

The vegetable oil line from the vegetable oil tank 1 to the output of the fuel supply control section 4 is basically the same as the vegetable oil line in the third embodiment except that a return passage of the second reservoir tank 44b is connected to a line between the second filter 47b and the second pump 41b. A check valve 23 and a solenoid valve 24 are installed in a passage connecting the fuel supply control section 4 and the gas turbine 5.

FIG. 7 shows experimental data during a switching from gaseous fuel to reformed frying oil. In this experiment, a switching from gaseous fuel to reformed frying oil was executed at a moment when 144 minutes elapsed from the start of the gas turbine 5 using gaseous fuel and when the temperature of the combustion chamber of the gas turbine approaches 200° C. Although this switching from gas to liquid requires to stop momentarily a combustion in the gas turbine 5, the reformed frying oil was sufficiently heated and therefore the reformed frying oil was quickly fired in the combustion chamber of the gas turbine 5. During a period from the switching at 144 minute to a moment when 4 minutes elapsed from the switching, the gas turbine 5 was operated to generate a generator output of 30 kw. Thereafter, until 160 minutes, the gas turbine 5 was operated to generate a generator output of 15 kw. Further, thereafter, at a moment that 160 minutes elapsed, a switching from reformed frying oil to kerosene was executed. As is clearly shown by the graph in FIG. 7, the gas turbine 5 stably operated throughout the whole operation period. It was confirmed that the switching from gaseous fuel to vegetable oil and the switching form vegetable oil to kerosene never affected an engine speed of the gas turbine S and the output of the generator.

With the thus arranged embodiments according to the present invention, the gas turbine 5 starts the operation using kerosene (fluid fuel), which is preferable as fuel. Thereafter, when the temperature of vegetable oil becomes higher than the predetermined temperature at which the flowability of vegetable oil reaches a level usable as fuel, the switching to vegetable oil is executed. This arrangement enables the switching from kerosene to vegetable oil to he smoothly switched.

Further, these embodiments according to the present invention are arranged such that the switching from vegetable oil to kerosene is executed when the vegetable oil line is put in the abnormal state. Accordingly, even if the vegetable oil line is put in the abnormal state due to the empty of vegetable oil or the clogging of the vegetable oil line, the gas turbine 5 can continue the operation without generating sudden stop. This contributes to decreasing the cost for electric-power generation even if vegetable oil is employed as fuel. Further, this system is advantageous in view of environmental protection and effective use of resources.

This application is based on Japanese Patent Applications No. 2002-170793 filed on Jun. 12, 2002, and No. 2001-388796 filed on Dec. 21, 2001 in Japan. The entire contents of these Japanese Patent Applications are incorporated herein by reference.

Although the invention has been described above by reference to certain embodiments of the invention, the invention is not limited to the embodiments described above. Modifications and variations of the embodiments described above will occur to those skilled in the art, in light of the above teaching. The scope of the invention is defined with reference to the following claims.

What is claimed is:

1. A generator set for reformed vegetable oil, comprising:
a fluid fuel tank storing fluid fuel;
a vegetable oil tank storing reformed vegetable oil;
a gas turbine generating electric power by consuming the reformed vegetable oil as fuel;
a fuel supply control section fluidly connected to the fluid fuel tank, the vegetable oil tank and the gas turbine, the fuel supply control section controlling pressure of the fluid fuel supplied from the fluid fuel tank and pressure of the reformed vegetable oil supplied from the vegetable oil tank, the fuel supply control section supplying the pressure controlled fluid fuel and the pressure controlled reformed vegetable oil to the gas turbine; and
first and second valves selectively supplying the fluid fuel in the fluid fuel tank and the reformed vegetable oil in the vegetable oil tank to the fuel supply control section.

2. The generator set as claimed in claim 1, wherein the fuel supply control section comprises a pump for pressuring the selected one of the fluid fuel and the reformed vegetable oil.

3. The generator set as claimed in claim 2, wherein the fuel supply control section comprises a relief valve and a reservoir tank which are disposed at an output portion of the pump, the relief valve maintaining pressure of the selected one of the fluid oil and the reformed vegetable oil, the reservoir tank receiving the selected one from the a relief valve and supplying the selected on to an input portion of the pump.

4. The generator set as claimed in claim 1, wherein the fuel supply control section comprises a filter for filtering the supplied one of the fluid fuel and the reformed vegetable oil.

5. The generator set as claimed in claim 1, wherein the gas turbine starts using the fluid fuel as fuel.

6. The generator set as claimed in claim 1, wherein the fluid fuel includes kerosene, light oil, LNG (liquefied natural gas) and LPG (liquefied petroleum gas).

7. The generator set as claimed in claim 1, wherein the gas turbine uses the fluid fuel for a predetermined time period from a start moment of the generator.

8. A generator set for reformed vegetable oil, comprising:
a gaseous fuel supply section supplying gaseous fuel;
a vegetable oil tank storing reformed vegetable oil;
a gas turbine generating electric power by a using the reformed vegetable oil as fuel;
a fuel supply control section fluidly connected to the vegetable oil tank and the gas turbine, the fuel supply control section controlling pressure of the reformed vegetable oil supplied from the reformed vegetable oil tank, the fuel supply control section supplying the pressure controlled reformed vegetable oil to the gas turbine, and
a booster connected to the gaseous fuel supply section, the booster pressurizing the gaseous fuel at a predetermined pressure value;
a first valve disposed in a passage connecting the booster and the gas turbine, the first valve being selectively opened and closed to selectively supply and stop the gaseous fluid to the gas turbine; and
a second value disposed in a passage connecting the vegetable oil tank and the fuel supply control section, the second valve being selectively closed and opened to selectively stop and supply the reformed vegetable oil to the gas turbine.

9. A generator set for reformed vegetable oil, comprising;
a fluid fuel tank storing fluid fuel;
a vegetable oil tank storing reformed vegetable oil;
a gas turbine generating electric power by using one of the fluid fuel and the reformed vegetable oil as fuel;
a fuel supply control section fluidly connected to the fluid fuel tank, the vegetable oil tank and the gas turbine, the fuel supply control section controlling pressure of the fluid fuel supplied from the fluid tank and pressure of the reformed vegetable oil supplied from the vegetable oil tank, the fuel supply control section supplying the pressure controlled fluid fuel and the pressure controlled reformed vegetable oil to the gas turbine;
first and second valves selectively supplying the fluid fuel in the fluid fuel tank and the reformed vegetable oil in the reformed vegetable oil tank to the fuel supply control section; and
a controller coupled to the gas turbine, the fuel supply control section and the first and second valves, the controller being configured,
to receive a gas-turbine operation signal indicative that the gas turbine is in an operable state and a load signal indicative that a load is applied to the gas turbine, from the gas turbine,
to receive a fuel supply condition signal indicative of a condition of the reformed vegetable oil from the fuel supply control section,
to command the fuel supply control section and the first and second valves to supply the reformed vegetable oil when the controller determines from the fuel supply condition signal that a temperature of the reformed vegetable oil is higher than a predetermined value and when the controller receives the load signal, and
to command the fuel supply control section, the first valve and the second valve to supply the fluid fuel when the controller does not receive the load signal.

10. The generator set as claimed in claim 9, wherein the fuel supply control section comprises a pump for pressuring the selected one of the fluid fuel and the reformed vegetable oil, and a filter for filtering the supplied one of the fluid fuel and the reformed vegetable oil.

11. The generator set as claimed in claim 9, wherein the fuel supply control section comprises a flow meter for measuring a flow rate of the fuel supplied to the gas turbine, and a temperature sensor for detecting a temperature of the fuel supplied to the gas turbine.

12. The generator set as claimed in claim 9, wherein the controller comprises:
fluid fuel selecting means for selecting the fluid fuel as when the gas-turbine standby signal is outputted,
first select continuing means for continuing selecting the fluid fuel as fuel when a temperature of the reformed vegetable oil is lower than a predetermined value,
second select continuing means for continuing selecting the fluid fuel as fuel when the temperature of the reformed vegetable oil is higher than the predetermined value and when no load is applied to the gas turbine,
vegetable oil selecting means for selecting the reformed vegetable oil as fuel when the load is applied to the gas turbine, and
supply stopping means for stopping supplying the fluid fuel to the gas turbine when the gas turbine is stopped.

13. A method of operating a generator set, the generator set comprising a gas turbine which selectively uses reformed vegetable oil and fluid fuel, the method comprising the steps of:
supplying the reformed vegetable oil to the gas turbine when a temperature of the reformed vegetable oil is higher than a predetermined temperature and a when a load is applied to the gas turbine; and
supplying the fluid fuel to the gas turbine when the temperature of the reformed vegetable oil is lower than the predetermined temperature or when no load is applied to the gas turbine.
